(19) United States
(12) Patent Application Publication
(10) Pub. No.: US 2020/0325045 A1
(43) Pub. Date: Oct. 15, 2020

(54) HYDROGEN GAS GENERATING BODY

(71) Applicant: Ecomo International Co., Ltd., Fukuoka (JP)

(72) Inventor: Kazuhisa FUKUOKA, Fukuoka (JP)

(21) Appl. No.: 16/913,726

(22) Filed: Jun. 26, 2020

Related U.S. Application Data
(63) Continuation-in-part of application No. PCT/JP2017/047411, filed on Dec. 29, 2017.

(51) Int. Cl. C02F 1/68; A23L 2/39; A23L 2/54; C01B 3/08

(52) U.S. Cl. CPC C02F 1/688; A23L 2/39; A23V 2002/00; C01B 3/08; B01D 2239/0618; A23L 2/54

(57) ABSTRACT

Provided is a hydrogen gas generating body capable of generating a hydrogen-added liquid in a shorter time than with conventional hydrogen-adding apparatuses. This hydrogen gas generating body is constituted by a hydrogen generating composition that generates hydrogen by retaining water, and a housing body formed to freely house the hydrogen generating composition by having a hydrogen gas permeable film overlaying a backing comprising a pouched non-woven fabric. The invention is also characterized in that: the housing body has the hydrogen gas permeable film overlaid on the inner side of the backing; the housing body has the hydrogen gas permeable film overlaid on the outer side of the backing; or the housing body comprises two layers of the backing with the hydrogen gas permeable film overlaid therebetween.

### CROSS REFERENCE TO RELATED APPLICATION

This Application is a continuation in part of PCT/JP2017/047411 filed on Dec. 29, 2017, the above application is incorporated herein by reference.

### TECHNICAL FIELD

The present invention relates to a hydrogen gas generating body producing hydrogen-containing liquid by containing hydrogen gas in liquid.

### BACKGROUND ART

Water which we ingest on a daily basis plays an extremely important role for creating a foundation for health and focus on drinking water is further increased while growing health consciousness among people.

Conventionally, it is proposed various drinking water meeting such above needs. For example, it is well-known oxygen water in which a lot of oxygen is dissolved in drinking water and hydrogen water in which hydrogen is dissolved.

Especially, it is conducted various reports contributing health concerning the hydrogen water in which molecular hydrogen is contained, such as decrease of in vivo oxidative stress, increase suppression of blood LDL.

Although such hydrogen water is produced by dissolving hydrogen in water, it is generally difficult to obtain hydrogen or to dissolve pure hydrogen in water.

Further, it is desirable that the hydrogen water is served for drinking as soon as possible after preparation of the hydrogen water since hydrogen is gradually released with time so long as a container with extremely low hydrogen permeability is not used.

Further, since drinking water is taken up by the body, it is necessary to prevent as much as possible elution of reaction residual or metallic ions and the like produced in a generation process of hydrogen.

Thus, in order to be able to prepare the hydrogen water with safe and easy in general household and the like, it is proposed a hydrogenation equipment in which a hydrogen generation composition is encapsulated in a bottomed cylindrical container with a length to an extent of several centimeters (for example, see PTL1).

According to the above hydrogenation equipment, the equipment is thrown into a PET bottle and the like in which water is accommodated and the PET bottle is sealed, thereby the hydrogen water can be produced by containing hydrogen in water.

By the way, in the conventional hydrogenation equipment according to PTL1, it is necessary operation to take out the hydrogen generation composition from a moisture-proof packaging bag, to insert independently the hydrogen generating composition into a closed container and further to add predetermined amount of water for reacting with the hydrogen generating composition and close a lid of the closed container.

Such troublesome operation is difficult, in particular, for a person being not good at the above fine work such as senior citizens, thus it is desired means capable of producing the hydrogen water more easily. In a selective hydrogenation equipment according to PTL2, the hydrogen generating composition is accommodated in a hydrogen babble forming body constituted from a gas permeable membrane, thereby the selective hydrogenation equipment is thrown into the container such as the PET bottle and the like having water therein and the container is sealed. According to only this simple operation, hydrogen is contained in water and the hydrogen water can be generated.

### CITATION LIST

### Patent Literature

[PLT1] Japanese Patent No. 4652479

[PLT2] Japanese Patent No. 4950352

### SUMMARY OF INVENTION

### Technical Problem

The above selective hydrogenation equipment according to PTL2 is quite better at a point that the hydrogen containing liquid can be easily obtained even by a person being not good at fine work such as at least senior citizens.

However, in the selective hydrogenation equipment according to PTL2, water as liquid in drinking water cannot be distributed in the gas permeable membrane and only water as vapor or humid can be distributed and reacted with the hydrogen generating composition. Therefore, it takes a long time to generate enough amount of hydrogen so that the hydrogen water is supplied for drinking water, as a result, it is complicated.

The present invention has been done while taking the above circumstances into consideration and has an object to provide a hydrogen gas generating body in which liquid containing hydrogen (hereinafter, abbreviated as hydrogen-containing liquid) can be produced in a shorter time in comparison with the conventional hydrogenation equipment.

### Solution to Problem

In order to solve the above conventional problem, according to the hydrogen gas generating body according to the present invention, (1) in the hydrogen generating body for producing hydrogen-containing liquid by containing hydrogen in liquid when the hydrogen generating body is thrown into the liquid, the hydrogen gas generating body is constituted from hydrogen generating composition for generating hydrogen by hydrating thereof and a housing body in which a hydrogen gas permeable membrane is overlaid on a base material formed from a pouched non-woven fiber, the housing body being formed to freely house the hydrogen generating composition.

Further, the hydrogen gas generating body according to the present invention has also characteristic at the following points:

(2) in the above housing body, the hydrogen gas permeable membrane is overlaid on an inner side of the base material,
(3) in the above housing body, the hydrogen gas permeable membrane is overlaid on an outer side of base material,
(4) in the above housing body, the hydrogen gas permeable membrane is overlaid in a gap formed by constituting the base material in two layers.

### Advantageous Effects of Invention

By the hydrogen gas generating body according to the present invention, in the hydrogen generating body for producing hydrogen-containing liquid by containing hydrogen in liquid when the hydrogen generating body is thrown into the liquid, the hydrogen gas generating body is constituted from hydrogen generating composition for generating hydrogen by hydrating thereof and a housing body in which a hydrogen gas permeable membrane is overlaid with a base material formed from a pouched non-woven fiber, the housing body being formed to freely house the hydrogen generating composition. Thereby, the hydrogen gas permeable membrane which is easy to break is reinforced by the base material and mechanical strength of the housing body can be improved, moreover invasion of the liquid within the housing body can be promoted based on water content of the non-woven fiber.

Further, in the housing body, based on that the hydrogen gas permeable membrane is overlaid on the inner side of the base material, the base material of wet condition by the liquid forms stable liquid layer on the membrane surface when the hydrogen gas generating body is thrown into the liquid. Thereby, invasion of the liquid in the membrane is promoted, the liquid can be hydrated in the hydrogen gas generating composition within the housing body in a short time in comparison with a case that only the membrane exists, therefore the hydrogen can be generated.

Further, since the hydrogen permeable membrane can be protected by the outer base material, handling of the hydrogen gas generating body can be easily done.

Further, in the housing body, based on that the hydrogen gas permeable membrane is overlaid on the outer side of the base material, the early liquid invaded in the membrane is hydrated in the base material when the hydrogen gas generating body is thrown into the liquid, thereafter the outer liquid is derived in the housing body as the capillary phenomenon and invasion of the liquid within the membrane is promoted. Thereby, the liquid can be hydrated in the hydrogen gas generating composition within the housing body in a short time in comparison with a case that only the membrane exists, therefore the hydrogen can be generated.

Further, the base material becomes cushioning material against generation of heat at hydrogen producing reaction, therefore deterioration of the hydrogen gas permeable membrane due to heat generation can be prevented as much as possible.

Further, in the housing body, since the hydrogen gas permeable membrane is overlaid in the gap occurring based on that the base material is formed in two layers, the base material of wet condition by the liquid forms stable liquid layer on the membrane surface when the hydrogen gas generating body is thrown into the liquid. Thereby, invasion of the liquid in the membrane is promoted. Moreover, the early liquid invaded in the membrane is hydrated in the base material, thereafter the outer liquid is derived in the housing body as the capillary phenomenon and invasion of the liquid within the membrane is further promoted. Thereby, the liquid can be hydrated in the hydrogen gas generating composition within the housing body in a short time, therefore the hydrogen can be generated.

Further, the base material becomes cushioning material against generation of heat at hydrogen producing reaction, therefore deterioration of the hydrogen gas permeable membrane due to heat generation can be prevented as much as possible. In addition, since the hydrogen gas permeable membrane can be protected by the outer base material, handling of the hydrogen gas generating body can be easily done.

### BRIEF DESCRIPTION OF DRAWINGS

FIG. 1(a) is a partially perspective view of the hydrogen gas generating body according to the first embodiment.

FIG. 1(b) is a sectional view of FIG. 1(a) along a-a′ line.

FIG. 1(c) is a partially perspective view of the hydrogen gas generating body according to the second embodiment.

FIG. 1(d) is a sectional view of FIG. 1(c) along b-b′ line.

FIG. 1(e) is a partially perspective view of the hydrogen gas generating body according to the third embodiment.

FIG. 1(f) is a sectional view of FIG. 1(e) along c-c′ line.

FIG. 2 is an explanatory view to prepare the hydrogen-containing liquid by throwing the hydrogen gas generating body according to any of the first and the second embodiments into a preparation container.

FIG. 3 is an explanatory view indicating a process to constitute the hydrogen generating unit by accommodating the hydrogen gas generating body according to any of the first˜the fourth embodiments in the hydrogen generating container of the first example.

FIG. 4 is an explanatory view to prepare the hydrogen-containing liquid by throwing the hydrogen generating unit in which the hydrogen gas generating body according to any of the first to the fourth embodiments is accommodated in the hydrogen generating container according to the first into the preparation container.

### DESCRIPTION OF EMBODIMENTS

The present invention relates a hydrogen gas generating body producing hydrogen-containing liquid by containing hydrogen gas in liquid when the hydrogen gas generating body is thrown into the liquid.

Further, a characteristic point of the hydrogen gas generating body according to the present invention is that the hydrogen gas generating body is constituted from hydrogen generating composition generating hydrogen when hydrated and a housing body in which a hydrogen gas permeable membrane is overlaid on a base material formed from a pouched non-woven fiber, the housing body being formed to freely house the hydrogen generating composition.

Here, although the liquid to dissolve hydrogen is not especially limited, such liquid can be made as liquid used for not only human but also living body such as drink including water, juice, tea and the like or liquid medicine used for injection, drip infusion and the like.

Further, the hydrogen generating composition is not especially limited so long as the composition can generate hydrogen by contacting with water and such composition may be mixture.

As the mixture generating hydrogen by contacting with water, for example, it can be raised mixture of a metal or metal compound having ionizing tendency higher than hydrogen and a reaction accelerator such as acid or alkali and the like.

Further, as the metal preferably used, for example, it can be raised iron, aluminum, nickel, cobalt, zinc and the like and as the preferable reaction accelerator, for example, in addition to various acids, calcium hydroxide, calcium oxide, anion exchange resin, baked calcium, magnesium oxide, magnesium hydroxide and the like can be used.

Further, in the hydrogen generating composition, within a range that hydrogen producing reaction necessary for practice is not hindered, substance having functionality can be suitably added if necessary. For example, based on that substance generating endothermal reaction by contacting with water (for example, urea or substance corresponding to feed additive generating the same effects as the urea), heat generated according to hydrogen producing reaction can also be controlled.

Further, in the hydrogen generating composition, powdered calcium carbonate (CaCO₃) may be contained. The calcium carbonate functions as heat transmission substance which transmits heat generated with hydrogen by hydration of the hydrogen generating composition to the hydrogen permeable membrane. Based on existence of the calcium carbonate, heat is transmitted to the hydrogen permeable membrane and the hydrogen permeable membrane becomes soft. Further, since the hydrogen permeable membrane is expanded by generated hydrogen, fine holes through which hydrogen molecular and vapor are passed are further enlarged. Thereby, permeability of hydrogen and vapor is improved and hydrogen producing reaction can be further encouraged, as a result, the hydrogen-containing liquid can be produced in a shorter time.

The housing body has the hydrogen gas permeable membrane as release means to release hydrogen generated within the inside of housing body out of the hydrogen gas generating body and the housing body is formed by overlaying the hydrogen gas permeable membrane on the base material made from the pouched non-woven fiber which freely houses the hydrogen generating composition.

The hydrogen gas permeable membrane is a thin film to separate only hydrogen gas and release. As the hydrogen gas permeable membrane, it can be raised polymer membrane and the like such as aromatic polyimide, cellulose acetate and the like. Further, the hydrogen gas permeable membrane acts as function to restrain that solid residue or liquid of metal ions flows outside.

Further, in the hydrogen permeable membrane, only water as vapor invades within the membrane and only hydrogen gas is generally released from inside of the membrane. For example, as the hydrogen gas permeable membrane, it can be preferably used a so-called microporous film in which there are formed many fine holes that cannot permeate water in liquid state and can permeate hydrogen gas or vapor.

As mentioned in the above, according to the hydrogen gas generating body of the present embodiment, in comparison with the conventional hydrogenation equipment, hydrogen can be produced in a short time and moreover it can be strengthened prevention that vice-generative production after production of hydrogen flows into drinking water.

Further, in the hydrogen gas generating body mentioned in the above, when the hydrogen gas generating body is thrown into liquid, although vapor derived from liquid is made water to invade inside of the housing body and react with the hydrogen generating composition, it is not necessarily limited to this.

For example, as the hydrogen generating unit for producing hydrogen-containing liquid by throwing in liquid and containing hydrogen in liquid, such unit being proposed by the present inventor, it is used the housing body in which there are provided non-flowing state retaining means for retaining water in the non-flowing state under which water does not react with the hydrogen generating composition and release means for releasing hydrogen out of the hydrogen gas generating body, wherein the non-flowing state retaining means changes water in the non-flowing state to the flowing state under which water can react with the hydrogen generating composition by adding a predetermined amount of energy from outside of the housing body, wherein water in the flowing state reacts with the hydrogen generating composition by triggering through given energy and wherein hydrogen produced in the housing body is released in liquid through the release means. Thereby, without invasion of liquid into the hydrogen gas generating body or with invasion of liquid into the hydrogen gas generating body, it may be constituted that the hydrogen-containing liquid is produced. Here, the release means is not especially limited, for example, of course, needless to say for constitution of the housing body described in the present specification, it may be conceivable that the water-resistant hydrogen permeable membrane is constituted from water-proof breathable material, semi-transparent membrane, reverse osmosis membrane and is realized by mechanical valve mechanism such as check valve and further hydrogen gas is made releasable while retaining invasion of liquid into the housing body through capillary narrow path.

For example, the non-flowing state retaining means is a flexible partitioned room containing water in a sealed state and realizing the non-flowing state. This partitioned room is constituted so as to have a weak portion that ejects water contained therein by giving a predetermined amount of outer force as energy, thereby the flowing state is realized. Thus, a user presses the partitioned room, that is, a small pouch, in which water for reaction is contained, by fingers and breaks the pouch, thereby hydrogen generating reaction can be taken place.

Based on the above constitution, in comparison with the conventional hydrogenation equipment mentioned previously, production of hydrogen can be conducted in a short time.

Hereinafter, the hydrogen generating body according to the present embodiment will be described with reference to the drawings.

### First Embodiment

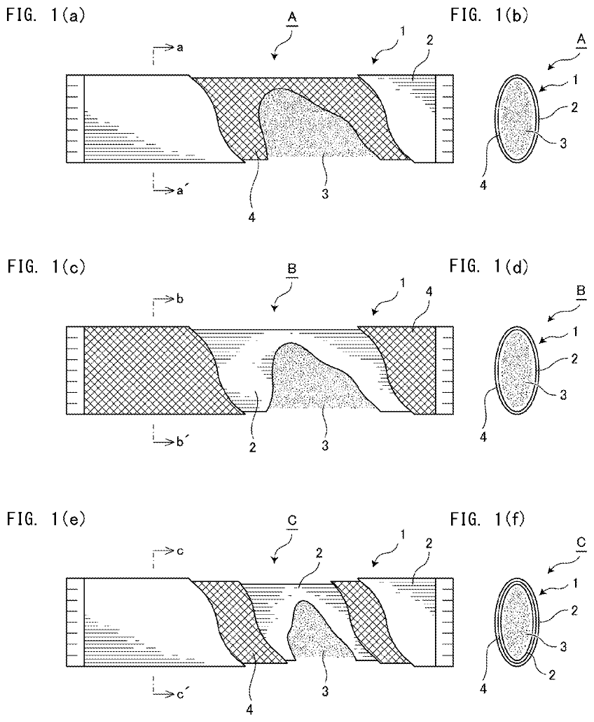

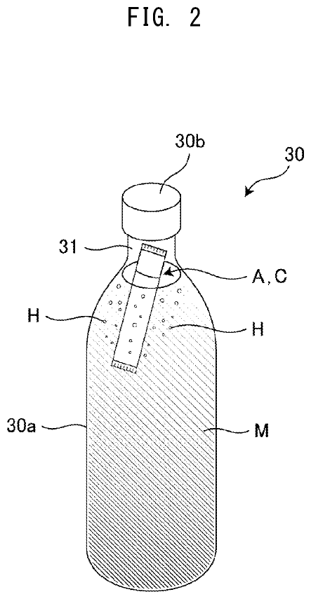

As shown in FIGS. 1 (a), 1 (b), and 2, the hydrogen gas generator A according to the first embodiment is a hydrogen gas generator A which is charged into a liquid M to contain hydrogen in the liquid M to produce a hydrogen-containing liquid, wherein the hydrogen gas generator A is composed of a hydrogen generating composition 3 which is hydrated and generates hydrogen, and a housing 1 in which the hydrogen generating composition 3 is formed so that the hydrogen generating composition 3 can be housed by superposing a hydrogen gas permeable film 4 on a base material 2 made of a bag-like nonwoven fabric.

In the housing 1, a hydrogen gas permeable membrane 4 is superposed on the inside of the base material 2.

FIG. 1A is a partial perspective view of the hydrogen gas generator A according to the present embodiment, and FIG. 1B is a sectional view taken along line a-a′ of FIG. 1A.

Concretely, the housing body 1 is formed in a long pouch and the hydrogen generating composition 3 is contained therein. Here, in all embodiments described hereinafter, the hydrogen generating composition 3 is a mixed powder containing aluminum and calcium hydroxide as main component.

By constituting the hydrogen gas generating body A in this way, the liquid M flowing into the housing body 1 from the outside as steam in use comes into contact with the hydrogen generating composition 3 to start the hydrogen generating reaction.

The hydrogen generating composition 3 containing the liquid M produces hydrogen gas H while producing alumina cement as a reaction residue in the hydrogen production reaction, and the hydrogen gas H is discharged to the outside through the housing 1.

Of the metal ions (aluminum ion) eluted by the hydrogen generating composition 3 containing the liquid M, the reaction residue of the metal ions not contributing to the formation of the alumina cement, such as the alumina cement, remains inside the housing 1, thereby preventing the outflow to the outside of the hydrogen gas generating body A.

Thus, although the hydrogen gas permeable membrane 4 is a thin film, it can be used as a hydrogen gas generator A by being overlapped with the base material 2, and the hydrogen gas permeable membrane 4 is brought close to or in contact with the base material 2, so that the liquid M is promoted to enter the inside of the housing 1 compared with the case of the membrane 4 alone, and the hydrogen gas H can be generated in a short time.

That is, when the hydrogen gas generator A is charged into the liquid M, the base material 2 in a wet state forms a stable liquid layer on the surface of the film 4 by the liquid M, whereby the intrusion of the liquid M into the film 4 is promoted, and the liquid M can be hydrated in the hydrogen generating composition 3 in the housing 1.

As mentioned in the above, the hydrogen gas generating body A is constituted according to the above.

Further, generating procedure of the hydrogen gas H will be concretely described. As shown in FIG. 2, the hydrogen generating body A is thrown into the drinking water M as the predetermined liquid contained in the preparation container 30, thereby the hydrogen-containing water can be prepared by containing hydrogen in the drinking water M.

The preparation container 30 is a PET bottle container of 500 ml which has a pressure resistance used when carbonated water and the like is sold and the preparation container 30 is constituted from a hollow container body 30a and a screw cap 30b which is screwed together with an upper opening of the container body 30a, thereby the container body 30a is surely sealed. Here, although the PET bottle (container made of polyethylene terephthalate) is used as the container in the present embodiment, it is not limited to this. It may be used a container made of glass, aluminum material and the like.

In the preparation container 30, the drinking water M is contained up to a portion near a bottle neck (48/50˜249/250 of inner volume of the preparation container 30), thereby liquid phase is formed. On the other hand, the upper portion thereof is made as the air reservoir 31, thereby gas phase is formed.

Concretely, the hydrogen gas generating body A is soaked in the drinking water M from the upper opening of the preparation container 30 in which the drinking water M is filled. Thereafter, as shown in FIG. 2, the preparation container 30 is sealed by the screw cap 30b. Thereby, the hydrogen gas H is released form the housing body 1.

The released hydrogen gas H is filled while enlarging the air reservoir 31 of the preparation container 30 and is dissolved in the drinking water M according to increase of inner pressure of the preparation container 30, thereby the hydrogen-containing water is prepared.

Here, the hydrogen gas generating body A according to the present embodiment is constituted so that hydrogen producing reaction is terminated for 10-20 hours after thrown into the preparation container 30. Thus, in a case that the user wants to drink right after the hydrogen-containing water is prepared, based on that the user grasps approximate center portion of the preparation container 30 and rapidly shakes about 180° in the left and right direction and for about 30 seconds, thereby stirs the preparation container 30, thereby it can be produced the hydrogen-containing liquid with 5.0˜7.0 ppm of hydrogen.

Further, it is constituted so that the preparation container 30 is settled for about 23 hours in a refrigerator after the hydrogen producing reaction is terminated and the preparation container 30 is stirred as mentioned in the above, thereby the hydrogen-containing liquid with about 7.0 ppm can be produced.

Here, generally, in the preparation container 30 in which the drinking water M is filled, the air reservoir 31 is formed as mention in the above. Since this air reservoir 31 becomes a factor to decrease concentration of content of hydrogen in production of hydrogen, it is preferable that the air reservoir 31 does not exist as much as possible when the hydrogen gas generating body A is thrown into and the preparation container 30 is sealed by the screw cap 30b.

As described above, the hydrogen gas generating body A according to the first embodiment is a hydrogen gas generating body A which generates a hydrogen-containing liquid by including hydrogen in the liquid M by charging the hydrogen gas generating body A into the liquid M, and the hydrogen gas generating body A is composed of the hydrogen generating composition 3 which is hydrated and generates hydrogen, and the housing body 1 which is formed so as to house the hydrogen generating composition 3 by superposing the hydrogen gas permeable membrane 4 on the inside of the base material 2 made of a bag-like nonwoven fabric, so that the hydrogen gas permeable membrane 4 which is easy to be broken is reinforced by the base material 2 to improve the mechanical strength of the housing body.

When the hydrogen gas generator (A) is charged into the liquid (M), the base material (2) in a wet state forms a stable liquid layer on the surface of the film (4) by the liquid (M), whereby the intrusion of the liquid (M) into the film (4) is promoted, and the liquid (M) can be hydrated in the hydrogen generating composition (3) inside the housing (1) in a shorter time than when the film (4) is alone to generate hydrogen.

Further, since the hydrogen gas permeable membrane 4 can be protected by the outer base material 2, the handling of the hydrogen gas generator A becomes easy.

Next, the hydrogen gas generating body C according to the second embodiment will be described. Here, the common portions with the hydrogen gas generation bodies A, B according to the first embodiments mentioned in the above will be described by adding the same reference signs and explanation thereof will be omitted as appropriate. In FIGS. 1 (c) and (d), the housing body 1 and the hydrogen gas permeable membrane 4 are reversed.

### Second Embodiment

In the hydrogen gas generating body C according to the second embodiment, as shown in FIGS. 1(e), (f) and FIG. 2, the housing body 1 is constituted so that the base material 2 made of pouched non-woven fiber is formed in two layers and the hydrogen gas permeable membrane 4 is overlaid in the gap.

Here, FIG. 1(e) is a partial perspective view of the hydrogen gas generating body according to the present embodiment and FIG. 1(f) is a sectional view of FIG. 1(e) along c-c′ line.

Based on that the hydrogen gas generating body C is constituted according to the above, the liquid M becoming vapor flowing into the housing body 1 from outside when used contacts with the hydrogen generating composition 3, thereby hydrogen producing reaction is started.

The hydrogen generating composition 3 hydrated by the liquid M produces hydrogen gas while producing alumina cement becoming reaction residue during hydrogen generating reaction and the hydrogen gas H is released outside by passing through the housing body 1.

Further, among metal ions (aluminum ion) eluted due to that the hydrogen generating composition 3 is hydrated by the liquid M, reaction residue of metal ion not contributing to production of alumina cement and alumina cement and the like is stored within the housing body 1, thereby it is prevented that these residues flows out from the hydrogen gas generating body C.

As mentioned, although the hydrogen gas permeable membrane 4 is a thin film, the hydrogen gas permeable membrane 4 can withstand use as the hydrogen gas generating body C by overlaying on the base material 2. Moreover, the hydrogen permeable membrane 4 is close to or contacts with the base material 2. Thus, invasion of the liquid M into the housing body 1 is promoted in comparison with a case that the membrane 4 is used alone and the hydrogen gas H can be generated in a short time.

That is, when the hydrogen gas generating body C is thrown into the liquid M, the outside base material 2 becoming wet state by the liquid M forms stable liquid layer on the surface of the membrane 4, thereby invasion of the liquid M into the membrane 4 is promoted and moreover the outside liquid M is lead into the housing body 1 as capillary phenomenon. Thus, invasion of the liquid M into the membrane 4 is further promoted and the liquid M can be hydrated in the hydrogen generating composition 3 existing in the housing body 1 in a short time.

The hydrogen gas generating body C according to the third embodiment is constituted corresponding to the above as mentioned. Here, generating procedure of the hydrogen gas H is as same as a case of the hydrogen gas generating body A according to the first embodiment.

As mentioned, in the hydrogen gas generating body C according to the third embodiment, the base material 2 has approximate same melting point as that of the hydrogen gas permeable membrane 4 and the base material 2 is constituted in two layers of the inner base material 2 a melting point of which is lower in composition with the outer base material 2 and the outer base material 2 a melting point of which is higher in comparison with the inner base material 2, further the hydrogen gas permeable membrane 4 is overlaid in the gap, thereby the housing body 1 is constituted. Therefore, welding cutting characteristic of sealing portion of the housing body 1 at manufacturing of the hydrogen gas generating body C is excellent. That is, when the opening end of the housing body 1 is sealed by heat welding after the hydrogen generating composition 3 is filled, the inner base material 2 and the hydrogen gas permeable membrane 4 are first melted by contacting of heated blade and the inner side plane of the housing body 1 is firmly sealed in mixed state. On the other hand, based on the outer base material 2 having relatively high melting point, sticky of molten substance to the heated blade can be avoided and beautiful cutting can be done. Further, when the hydrogen gas generating body C is thrown into the liquid M, the outer base material 2 in wet state forms stable liquid layer on the surface of the membrane 4 by the liquid M, thereby invasion of the liquid M into the membrane 4 is promoted and moreover early liquid M invading into the membrane 4 hydrates the inner base material 2. Thereafter, as capillary phenomenon, outer liquid M is leaded in the inside of the housing body 1 and invasion of the liquid M into the membrane 4 is further promoted. Thus, the liquid M can be hydrated in the hydrogen generating composition 3 within the housing body 1 in a short time, thereby hydrogen can be generated.

Further, the inner base material 2 becomes cushioning material against heat generation at the hydrogen producing reaction, therefore deterioration of the hydrogen gas permeable membrane 4 by heat generation can be prevented as much as possible, in addition, since the hydrogen gas permeable membrane 4 can be protected by the outer base material 2, handling of the hydrogen gas generating body C can be made easily.

Next, a hydrogen water producing kit X having each of hydrogen gas generating bodies A, C according to the above mentioned present embodiment will be described. The hydrogen gas generating bodies A, C mentioned in the above, for example, can produce the hydrogen-containing liquid while preventing flowing out of metallic ions without independently hydrogen generating container and the like against the liquid M contained in the container body 30a such as the PET bottle and the like. However, use with the hydrogen generating container is not disturbed.

Therefore, it is possible that the hydrogen water producing kit X is constituted by combining each hydrogen gas generating body A, C with a predetermined hydrogen generating container.

Further, the present inventor found, of course, that flowing out of metallic ions can be further restrained in a case that the hydrogen generating unit is constituted by combining with the predetermined hydrogen generating container and is thrown into the liquid M, and large amount of hydrogen can be generated from the hydrogen gas generating body A, C in a shorter time. Therefore, it can be said that the hydrogen gas generating body A, C is extremely advantageous for easily producing hydrogen-containing liquid with high concentration.

The hydrogen water producing kit X is a kit having mainly hydrogen generating body A, C, and a predetermined hydrogen generating container if necessary and auxiliary constitution element may be independently added. As auxiliary constitution element, for example, it can be raised a preparation container such as PET bottle and the like, an indicator to confirm concentration amount of dissolved hydrogen in the prepared hydrogen-dissolved liquid and a box for integrally packaging these and the like.

In the present specification, in particular, it will be described in detail several examples of the hydrogen generating container as the additional element of the hydrogen water producing kit X.

[Example of Hydrogen Generating Container]

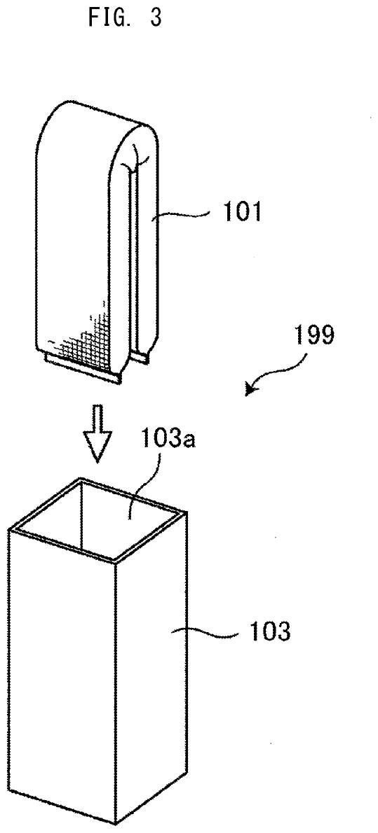

FIG. 3 is an explanatory view indicating a process constituting a hydrogen generating unit 199 by containing a hydrogen gas generating body 101 with any constitution of the hydrogen gas generating bodies A, C mentioned in the above within a hydrogen generating container 103.

The hydrogen generating unit 199 produces the hydrogen-containing liquid by containing hydrogen in the liquid M based on that the hydrogen generating unit 199 is thrown in the liquid M and the hydrogen generating unit 199 is constituted from three members of a hydrogen generating body 101, hydrogen generating composition 102 stored in a pouch thereof and the hydrogen generating container 103 constituted capable of storing the hydrogen gas generating body 101 with an opening portion 103a becoming a water communication hole, formed in an outer wall shown in FIG. 3.

The hydrogen generating container 103 is formed in a bottomed longitudinal cylinder in which the opening portion 103a to store the hydrogen gas generating body 101 is formed at one end. A predetermined water communication hole may be formed in the container outer wall other than the opening portion 103a. In this case, it may be provided an openable and closable lid member to the opening portion 103a for storing the hydrogen gas generating body 101. In a case that an inner space shape of hydrogen generating container 103 is made in a right-angles parallelepiped which has a long side in the depth direction as shown in FIG. 3 and in a case that an opening shape of the opening portion 103a is defined by vertical x horizontal, vertical or horizontal may be respectively formed in a length larger than a thickness of the hydrogen gas generating body 101 folded in half (length corresponding to twice of thickness of the hydrogen gas generating body 101) or may be formed in a length larger than a short side width of the hydrogen gas generating body 101 (however, any of them is a length to an extent that the hydrogen gas generating body 101 does not take off from the hydrogen generating container 103).

Moreover, in the hydrogen generating container 103, it is formed a space capacity 198 in which the longitudinal hydrogen gas generating body 101 folded in half can be contained. Here, although polypropylene which is plastic sheet with excellent sealing characteristic is used for material of the hydrogen generating container 103, such material is not especially limited.

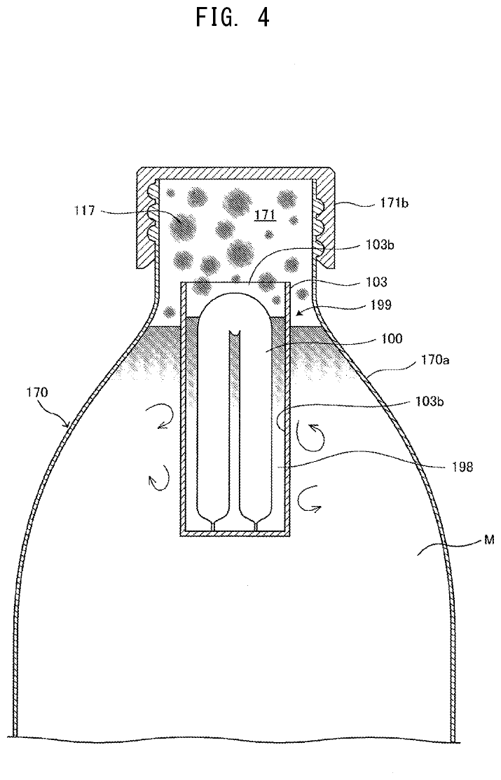

The longitudinal hydrogen gas generating body 101 is folded in half and contained in the hydrogen generating container 103. As shown in FIG. 4, the hydrogen generating container 103 is thrown into the preparation container 170 (for example, PET bottle) as it is and when the preparation container 170 is shaken, vapor derived from the liquid M within the preparation container 170 is penetrated in the hydrogen gas generating body 101, thereby vapor is reacted with the hydrogen generating composition 102. At that time, it is one characteristic point that appropriate conditions necessary for controlling constantly and stably hydrogen generating concentration, hydrogen generating amount and hydrogen generating time are set.

That is, the stable and optimal hydrogen reaction condition is determined so that it is controlled mutual relation between the water temperature of reaction water when the hydrogen gas generating body 101 is contained in the hydrogen generating container 103 and water flows into from the opening portion 103a at one end of the hydrogen generating container 103 and the space capacity 198 between the hydrogen gas generating body 101 contained in the hydrogen generating container 103 and the inner wall 103b of the hydrogen generating container 103.

Optimal and stable hydrogen production can be done by conducting the mutual relation control between the water temperature of reaction water necessary for mutual relation control, that is, water temperature of reaction water (a part of the liquid M) within the hydrogen generating container 103 affected by temperature of the liquid M in a peripheral of the hydrogen generating container 103 and reaction water amount (almost same as the space capacity 198) invaded in a remaining space within the hydrogen generating container 103 in which the hydrogen gas generating body 101 is contained.

In particular, since heat generation at the time of hydrogen reaction is high temperature of 70˜80° C., hydrogen generating condition is changed because the reaction water invading within the narrow space capacity 198 in the hydrogen generating container 103 is naturally heated, thereby hydrogen concentration and other conditions becomes unstable. Therefore, since cooling operation by temperature of the liquid M as peripheral circumstance of the hydrogen generating container 103 is also influenced, early water temperature of drinking water before the hydrogen gas generating body 101 is thrown in becomes important control element.

Further, in a case that the preparation container 170 is served for drinking while the hydrogen generating unit 199 is contained in the preparation container 170, shape and size of each of members constituting the hydrogen generating unit 199 can be set so that such members do not clog throat of drinker. That is, in a case that the drinker drinks the liquid M in a state that the hydrogen generating unit 199 is not removed from the preparation container 170, the hydrogen gas generating body 101 is flown out from the opening portion 103a of the hydrogen generating container 103 and there is fear that the body 101 clog throat of the drinker. In order to prevent this, for example, as mentioned in the above, it may be adopted a constitution that an openable and closable lid body is provided to the opening portion 103a of the hydrogen generating container 103, thereby it can be prevented that the hydrogen gas generating body 101 ids flown out.

Further, even in a case that the hydrogen generating unit 199 itself is falsely drunk, it may be formed the hydrogen generating container 103 with a size or shape (for example, capsule state) that the hydrogen generating unit 199 does not clog throat of the drinker.

Here, it will be described a preferable volume of the hydrogen generating unit 199. Generally, the air reservoir 171 as mentioned in the above exists within the preparation container 170in which the liquid M is filled. Since this air reservoir 171 becomes a factor to decrease concentration of content of hydrogen in the hydrogen production, it is desirable as much as possible that the air reservoir 171 does not exist when the hydrogen generating unit 199 is thrown in and the preparation container 170 is sealed by the screw cap 170b.

Therefore, it is desired the volume of the hydrogen generating container 103 in the hydrogen generating unit 199 approximates or exceeds the volume of the early air reservoir 171 before the hydrogen generating unit 199 is thrown in. Thus, also in the hydrogen generating unit 199, the volume of the hydrogen generating container 103 is formed so as to become such volume of the air reservoir 171, as a result, the hydrogen generating container 103 is formed so that the air reservoir 171 scarcely exists.

Here, as a method to make the air reservoir 171 minimum, it is possible by independently throwing a spacer member with a shape of rectangle block made of material harmless to the living body or beads into the preparation container 170.

The hydrogen generating unit 199 was constituted by using the hydrogen generating container 103 constituted according to the above and the hydrogen generating unit 199 was thrown into the PET bottle of 500 ml in which water as the liquid M is contained. Further, the hydrogen concentration was actually measured, as a result, it was shown that the hydrogen water with high concentration can be prepared, in comparison with a case that only the hydrogen gas generating body 101 was thrown in without using the hydrogen generating container 103. Concretely, an average (number of trials is 13 times) of a case that only the hydrogen gas generating body 101 was thrown in was 7.96 ppm. Contrarily, in a case that the hydrogen generating unit 199 was constituted by using the hydrogen generating container 103 and hydrogen was generated, the hydrogen water with high concentration an average of which was 8.07 ppm exceeding 8.0 ppm could be produced.

Further, by using two hydrogen generating container 103 having relatively different space capacity 198 shown in FIG. 4 (accommodation space of the hydrogen gas generating body 101 and a apace to rule reaction water amount invaded in remaining space in the hydrogen generating container 103), temperature change of the hydrogen gas generating body 101 was measured in each case.

As a result, the hydrogen generation composition 102 stored in the hydrogen gas generating body 101 in a case of small space capacity 198 started the reaction with the liquid M (production of hydrogen) for about 1 minute to 1 minute 30 seconds after thrown in the liquid M and a peak of the reaction occurred for about 3 minutes 30 seconds to 4 minutes and reached 93.1° C. which is the maximum temperature. Thereafter, the temperature of the hydrogen generating composition 102 gradually decreased and lowered to about 30° C. after 20 minutes.

On the other hand, the hydrogen generation composition 102 stored in the hydrogen gas generating body 101 in case of large space capacity 198 started the reaction with the liquid M (production of hydrogen) for about 3 minutes to 3 minutes 30 seconds after thrown in the liquid M and a peak of the reaction occurred for about 5 minutes to 5 minutes 30 seconds and reached 93.1° C. which is the maximum temperature. Thereafter, the temperature of the hydrogen generating composition 102 gradually decreased and lowered to about 30° C. after 20 minutes.

Here, the hydrogen generating composition 102 stored in the hydrogen gas generating body 101 in case of not existence of the hydrogen generating container 103 started the reaction with the liquid M (production of hydrogen) after thrown in the liquid M and 3 minutes passed and a peak of the reaction occurred after about 3 minutes and 30 seconds passed and reached 80.0° C. which is the maximum temperature. Thereafter, the temperature of the hydrogen generating composition 102 gradually decreased and lowered to about 30° C. after 10 minutes.

Based on these results, in the reaction of the hydrogen generating composition 102 thrown into the liquid M and the liquid M, the time reaching the peak of the reaction is slower (about 3 minutes˜4 minutes or about 5 minutes˜5 minutes 30 seconds) in a case that the hydrogen generating container 103 exists and the maximum temperature of the hydrogen generating composition 102 (93.1° C. or 95.6° C.) is also higher. Further, temperature decrease of the hydrogen generating composition 102 after peak is faster in a case that the hydrogen generating container 103 does not exist.

Further, additionally speaking, there is characteristic that reaction start time and reach time to peak of reaction becomes slower in the hydrogen gas generating body 101 stored in the hydrogen generating container 103 with large space capacity 198 than in the hydrogen gas generating body 101 stored in the hydrogen generating container 103 with small space capacity 198. This is considered that reaction is promoted in the limited space in case of the hydrogen gas generating body 101 stored in the hydrogen generating container 103 with small space capacity 198 (however, the hydrogen gas generating body 101 can be surely contained).

Further, in a case that the hydrogen gas generating body 101 is directly thrown in the preparation container 170, reaction with the liquid M (production of hydrogen) within the preparation container 170 is started after about 3 minutes-3 minutes 30 seconds are passed after throw. After about 6 minutes are passed, peak of reaction reaches. At that time, the temperature of the hydrogen generating composition 102 reaches 34.7° C. which is maximum temperature. Thereafter, the temperature of the hydrogen generating composition 102 is gradually decreased and lowered to about 30° C. after 20 minutes.

Generally, in case of hydrogen reaction of the liquid M and the hydrogen generating composition 102, the reaction is promoted in a high temperature state. Thus, in the hydrogen generating composition 102 of the hydrogen gas generating body 101 contained in the small space capacity 198 within the hydrogen generating container 103, the hydrogen reaction is promoted by the liquid M (reaction water) invading in the space capacity 198 within the hydrogen generating container 103. Further, as for the liquid M invaded in the space capacity 198 within the hydrogen generating container 103, it is added a factor that heat exchange with the liquid M around the hydrogen generating container 103 is hindered by the hydrogen generating container 103 and temperature decrease of the liquid M invading in the space capacity 198 within the hydrogen generating container 103 becomes smaller than a case that the hydrogen generating container 103 is not used. This is clear from a result of temperature change of the hydrogen generating composition 102 measured by directly throwing the hydrogen gas generating body 101 storing the hydrogen generating composition 102 into the preparation container 170.

That is, as in the present embodiment, the surrounding liquid M reacting with the hydrogen generating composition 102 can be retained toa higher temperature in a case that the hydrogen generating unit 199 is constituted by containing the hydrogen gas generating body 101 in the space capacity 198 of the hydrogen generating container 103, in comparison with a case that the hydrogen generating container 103 is not used. Thereby, it is considered that hydrogen reaction of the hydrogen generating composition 102 and the liquid M is promoted. Further, it is considered that the smaller the space capacity 198 within the hydrogen generating container 103 becomes, the more the hydrogen reaction of the hydrogen generating composition 102 and the liquid M is promoted.

As a result, based on the measured data mentioned in the above, it is guessed that the hydrogen reaction of the hydrogen composition 102 and the liquid M is promoted and high temperature state can be easily retained, thus average concentration of hydrogen produced in the liquid M becomes higher in a method that the hydrogen generating unit 199 having the hydrogen generating container 103 is thrown into the preparation container 170 than in a method that the hydrogen gas generating body 101 is thrown into the preparation container 170.

As mentioned, as for the hydrogen generating unit 199 in the first example of the hydrogen generating container, in the hydrogen generating unit 199 producing the hydrogen-containing liquid by throwing in the liquid M and containing hydrogen in the liquid M, wherein the hydrogen generating unit 199 is constituted from the hydrogen generating composition 102 generating hydrogen by being hydrated, the the hydrogen gas generating body 101 containing the hydrogen generating composition 102 and the hydrogen generating container 103 constituted capable of containing the hydrogen gas generating body 101. Moreover, it can be said that the hydrogen generating unit 199 is characteristically constituted at a point that mutual relation between the water temperature of reaction water within the hydrogen generating container 103 and the space capacity 198 in the hydrogen generating container 103 can be controlled.

Finally, the above-mentioned respective embodiments merely show one example of the present invention, and the present invention is not limited to the above-mentioned embodiments. Accordingly, it is needless to say that, besides the above-mentioned respective embodiments, various modifications are conceivable corresponding to designs and the like without departing from the technical concept of the present invention.
A hydrogen generating body (first embodiment)
B hydrogen generating body (second embodiment)
C hydrogen generating body (third embodiment)
H hydrogen gas
M liquid
container body
base material
hydrogen generating composition
hydrogen gas permeable membrane
101 hydrogen gas generating body
103 hydrogen generating container

1. In a hydrogen gas generating body for producing hydrogen-containing liquid by throwing into liquid and containing hydrogen in the liquid,
the hydrogen gas generating body comprising:
hydrogen generating composition generating hydrogen by being hydrated;
a containing body formed by overlaying a hydrogen gas permeable membrane on a base material made of pouched un-woven fiber, the containing body being capable of freely containing the hydrogen generating composition.

2. The hydrogen gas generating body according to claim 1, wherein the hydrogen gas permeable membrane is overlaid on an inner side of the base material.

3. The hydrogen gas generating body according to claim 1, wherein the hydrogen gas permeable membrane is overlaid on an outer side of the base material.

4. The hydrogen gas generating body according to claim 1, wherein the base material is formed in two layers and the hydrogen gas permeable membrane is overlaid in a gap formed in the two layers.
